(19) United States
(12) Patent Application Publication
(10) Pub. No.: US 2024/0217496 A1
(43) Pub. Date: Jul. 4, 2024

(54) BRAKE SYSTEM WITH REDUNDANT COMPONENTS

(71) Applicant: ZF Active Safety US Inc., Livonia, MI (US)

(72) Inventor: Blaise J. Ganzel, Ann Arbor, MI (US)

(21) Appl. No.: 18/093,056

(22) Filed: Jan. 4, 2023

(51) Int. Cl. B60T 13/66

(52) U.S. Cl. CPC B60T 13/662; B60T 2270/402

(57) ABSTRACT

A brake system includes a power transmission unit with a first electric motor. An iso/dump control valve arrangement is associated with each wheel brake of first and second pairs of wheel brakes. At least two pump pistons are provided, each pump piston being associated with at least one wheel brake. The at least two pump pistons are driven by a second electric motor for selectively providing pressurized hydraulic fluid to the iso/dump control valve arrangement of the at least one associated wheel brake in at least a backup braking mode. A dual lane electronic control unit is provided for controlling the first electric motor. The dual lane electronic control unit includes first and second ECU lanes. A single lane electronic control unit is provided for controlling the second electric motor.

### TECHNICAL FIELD

This disclosure relates to an apparatus and method for use of a brake system and, more particularly, to a method and apparatus of a brake system with redundant components.

### BACKGROUND

This invention relates in general to vehicle braking systems. Vehicles are commonly slowed and stopped with hydraulic brake systems. These systems vary in complexity but a base brake system typically includes a brake pedal, a master cylinder, fluid conduits, which can be arranged in two similar but separate brake circuits, and wheel brakes in each circuit. The driver of the vehicle operates a brake pedal which is directly or indirectly connected to the master cylinder. When the brake pedal is depressed, the master cylinder generates hydraulic forces in both brake circuits by pressurizing brake fluid. The pressurized fluid travels through the fluid conduit in both circuits to actuate brake cylinders at the wheels to slow the vehicle.

Base brake systems typically use a brake booster which provides a force to the master cylinder which assists the pedal force created by the driver. The booster can be vacuum or hydraulically operated. A typical hydraulic booster senses the movement of the brake pedal and generates pressurized fluid which is introduced into the master cylinder. The fluid from the booster assists the pedal force acting on the pistons of the master cylinder which generate pressurized fluid in the conduit in fluid communication with the wheel brakes. Thus, the pressures generated by the master cylinder are increased. Hydraulic boosters are commonly located adjacent the master cylinder piston and use a boost valve to control the pressurized fluid applied to the booster.

During initial movement of the brake pedal unit in boosted mode, the driver pushes on the brake pedal, causing initial movement of an input piston of the master cylinder. Further movement of the input piston will pressurize the input chamber of the master cylinder, causing fluid to flow into a pedal simulator. As fluid is diverted into the pedal simulator, a simulation pressure chamber within the pedal simulator will expand, causing movement of a piston within the pedal simulator. Movement of the piston compresses a spring assembly housed within the pedal simulator and biasing the piston to provide a feedback force to the driver of the vehicle via the brake pedal which simulates the forces a driver feels at the brake pedal in a conventional vacuum assist hydraulic brake system, for example, and therefore is an expected and comforting “brake feel” for the driver.

When the vehicle is first started, the brake fluid is under little to no pressure. In certain cases, the driver manually applies the brake in a “push-through” condition, in which the master cylinder directly energizes pressure to at least two, and often four, of the wheel brakes. As the brake system comes online and pressure builds, the system transitions to a “boost” mode wherein the booster is used to supplement or supplant pressurized fluid sent to the wheel brakes from the driver's push-through force on the brake pedal. However, this is not always a smooth transition and can result in a “pedal drop” condition when the pedal simulator is pressurized that can be discomfiting to the driver.

Descriptions of prior art brake systems are in U.S. Pat. No. 10,730,501, issued 4 Aug. 2020 to Blaise Ganzel and titled “Vehicle Brake System with Auxiliary Pressure Source”, and in U.S. Patent Application Publication No. 1020/0307538, published 1 Oct. 2020 by Blaise Ganzel and titled “Brake System with Multiple Pressure Sources”, in U.S. Patent Application Publication No. 1022/0274575, published 1 Sep. 2021 by Blaise Ganzel and titled “Hydraulic Brake Boost”, in U.S. patent application Ser. No. 17/708,070, filed 30 Mar. 2022 by Blaise Ganzel and titled “Tandem Power Transmission Unit and Brake Systems Using Same” (hereafter referenced as “the '070 application”), and in U.S. patent application Ser. No. 17/708,048, filed 30 Mar. 2022 by Blaise Ganzel and titled “Unloading Valve and Brake System Using Same” (hereafter referenced as “the '048 application”), all of which are incorporated herein by reference in their entirety for all purposes.

### SUMMARY

In an aspect, alone or in combination with any other aspect, a brake system for actuating first and second pairs of wheel brakes is provided. A power transmission unit is configured for selectively providing pressurized hydraulic fluid to first and second PTU outputs for actuating respective first and second pairs of wheel brakes in a normal non-failure braking mode. The power transmission unit includes a first electric motor. An iso/dump control valve arrangement is associated with each wheel brake of the first and second pairs of wheel brakes. A first traction control iso valve is hydraulically interposed between the first PTU output and at least one iso/dump control valve arrangement. A second traction control iso valve is hydraulically interposed between the second PTU output and at least one iso/dump control valve arrangement. At least two pump pistons are provided, each pump piston being associated with at least one wheel brake. The at least two pump pistons are driven by a second electric motor for selectively providing pressurized hydraulic fluid to the iso/dump control valve arrangement of the at least one associated wheel brake in at least a backup braking mode. A reservoir is hydraulically connected to the power transmission unit and each of the at least two pump pistons. A dual lane electronic control unit is provided for at least partially controlling the first electric motor. The dual lane electronic control unit includes first and second ECU lanes. The first ECU lane is operative to control at least a portion of the first electric motor in at least one of the normal non-failure braking mode and the backup braking mode. The second ECU lane is operative to control at least a portion of the first electric motor under at least one of the normal non-failure braking mode and the backup braking mode A single lane electronic control unit Is provided for controlling the second electric motor in at least one of the normal non-failure braking mode and the backup braking mode.

### BRIEF DESCRIPTION OF THE DRAWING

For a better understanding, reference may be made to the accompanying drawing, in which:

FIG. 1 is a schematic hydraulic diagram of a brake system.

### DESCRIPTION OF ASPECTS OF THE DISCLOSURE

Unless defined otherwise, all technical and scientific terms used herein have the same meaning as is commonly understood by one of ordinary skill in the art to which the present disclosure pertains.

The invention comprises, consists of, or consists essentially of the following features, in any combination.

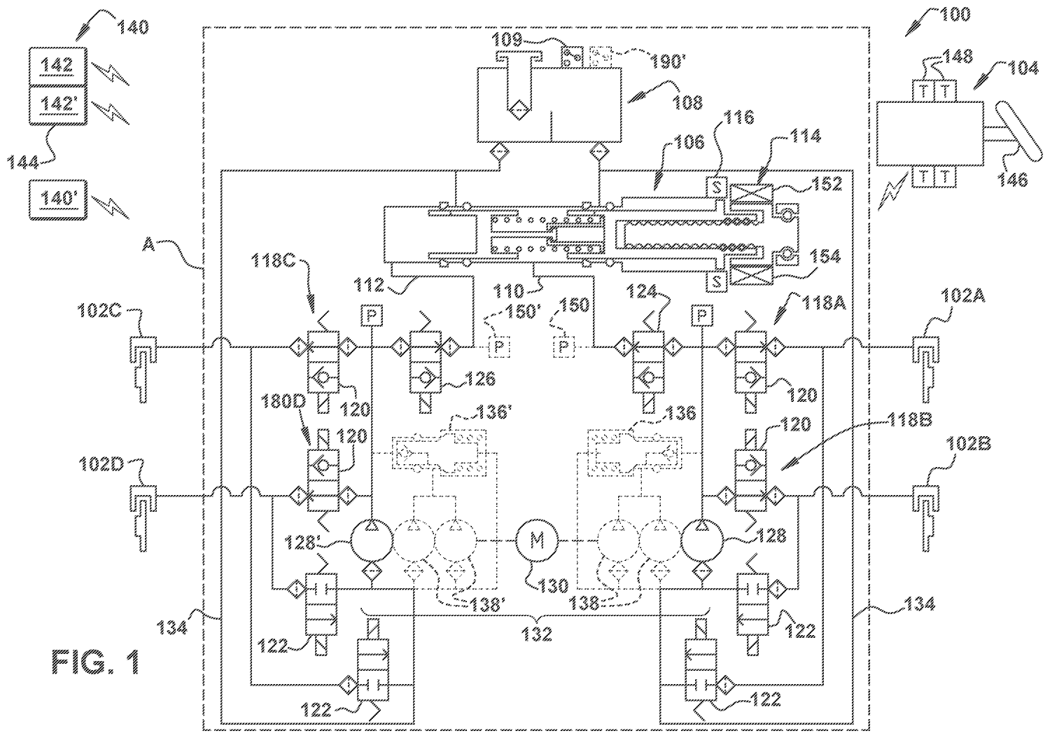

FIG. 1 schematically depicts a brake system 100. The brake system 100 is a hydraulic boost braking system in which boosted fluid pressure is utilized to apply braking forces for the brake system 100. The brake system 100 may suitably be used on a ground vehicle, such as an automotive vehicle having four wheels with a wheel brake associated with each wheel. Furthermore, the brake system 100 can be provided with other braking functions such as anti-lock braking (ABS) and other slip control features to effectively brake the vehicle. Components of the brake system 100 may be housed in one or more blocks or housings. The block or housing may be made from solid material, such as aluminum, that has been drilled, machined, or otherwise formed to house the various components. Fluid conduits may also be formed in the block or housing

The brake system 100 includes a plurality of wheel brakes 102 comprising first and second pairs of wheel brakes 102. In the illustrated embodiment of the brake system 100, there are four wheel brakes 102 depicted, by way of example. The wheel brakes 102 can have any suitable wheel brake structure operated by the application of pressurized brake fluid. Each of the wheel brakes 102 may include, for example, a brake caliper mounted on the vehicle to engage a frictional element (such as a brake disc) that rotates with a vehicle wheel to effect braking of the associated vehicle wheel. The wheel brakes 102 can be associated with any combination of front and rear wheels of the vehicle in which the brake system 100 is installed. For example, the brake system 100 may be configured as shown such that a primary pressure circuit is associated with providing fluid to a first pair of wheel brakes 102A and 102B, and a secondary pressure circuit is associated with providing fluid to a second pair of wheel brakes 102C and 102D. In some use environments, the first and second pairs of wheel brakes 102 may be front and rear pairs of wheel brakes 102. In other use environments, each of the first and second pairs of wheel brakes 102 may includes a front wheel brake 102 from a selected lateral (left/right) side of the vehicle and a rear wheel brake 102 from an opposite lateral (right/left) side of the vehicle. One of ordinary skill in the art will be able to readily configure a plurality of wheel brakes 102 as desired for a particular use environment.

The brake system 100 generally includes a brake pedal unit, indicated generally at 104, a power transmission unit 106, and a fluid reservoir 108. The reservoir 108 stores and holds hydraulic fluid for the brake system 100. The fluid within the reservoir 108 is preferably held at or about atmospheric pressure, but the fluid may be stored at other pressures if desired. The reservoir 108 is shown schematically having two tanks or sections with two fluid conduit lines connected thereto. The sections can be separated by one or more interior walls within the reservoir 108 and are provided to prevent complete drainage of the reservoir 108 in case one of the sections is depleted due to a leakage via one of the two lines connected to the reservoir 108. Alternatively, the reservoir 108 may include multiple separate housings. The reservoir 108 may include at least one fluid level sensor 109 for detecting the fluid level of one or more of the sections of the reservoir 108.

The power transmission unit 106 of the brake system 100 functions as a source of pressure to provide a desired brake fluid pressure level to the wheel brakes 102 during a typical or normal non-failure brake apply. After a brake apply, fluid from the wheel brakes 102 may be returned to the power transmission unit 106 and/or diverted to the reservoir 108. In the depicted embodiment, the power transmission unit 106 is configured for selectively providing pressurized hydraulic fluid to first and second PTU outputs 110, 112 for actuating respective first and second pairs of wheel brakes 102 in at least one of a normal non-failure braking mode and a backup braking mode. The power transmission unit 106 includes a first electric motor 114. The power transmission unit 106 may be a tandem power transmission unit 106, similar to that described in the '070 application.

A PTU sensor 116 can be provided to assist with determining a rotational status (direction, magnitude, speed, or any other quality) of the first electric motor 114, for use in calculations and/or control by any other component(s) of the brake system 100 as desired.

An iso/dump control valve arrangement 118 is associated with each wheel brake 102 of the first and second pairs of wheel brakes 102. Each iso/dump control valve arrangement 118 includes an iso valve 120 and a dump valve 122, for providing desired fluid routing to an associated wheel brake 102 for at least normal non-failure braking control. The normally open iso valve 120 for each iso/dump control valve arrangement 118 is located hydraulically between a respective wheel brake 102 and the power transmission unit 106, and the normally closed dump valve 122 for each iso/dump control valve arrangement 118 is located hydraulically between a respective wheel brake 102 and the reservoir 108, for the corresponding wheel brake 102.

The iso/dump control valve arrangements 118 may selectively provide slip control to at least one wheel brake 102 powered by the power transmission unit 106 and/or the pump/motor unit described below. More broadly, the iso/dump control valve arrangements 118, and/or other valves of the brake system 100, any of which may be solenoid-operated and have any suitable configurations, can be used to help provide controlled braking operations, such as, but not limited to, ABS, traction control, vehicle stability control, dynamic rear proportioning, regenerative braking blending, and autonomous braking.

A first traction control iso valve 124 is hydraulically interposed between the power transmission unit 106 and at least one iso/dump control valve arrangement 118 via the first PTU output 110. A second traction control iso valve 126 is hydraulically interposed between the power transmission unit 106 and at least one iso/dump control valve arrangement 118 via the second PTU output 112.

At least two pump pistons 128 are provided, with each pump piston 128 being associated with at least one wheel brake 102. The pump pistons 128 are driven by a second electric motor 130 (as differentiated from the first electric motor 114 included in the power transmission unit 106) for selectively providing pressurized hydraulic fluid to the iso/dump control valve arrangement 118 of at least one wheel brake 102 which is associated with the pump piston 128, in a backup braking mode and/or during normal slip control operation. In FIG. 1, each pump piston 128 is associated with two wheel brakes 102, for a total of two pump pistons 128 in the brake system 100. The reservoir 108 is hydraulically connected to the power transmission unit 106 and to each of the at least two pump pistons 128. Together, the pump piston(s) 128 and second electric motor 130 can be considered to comprise a secondary brake module 132 of the brake system 100.

The secondary brake module 132 of the brake system 100 functions as a source of pressure to provide a desired pressure level to selected ones of the wheel brakes 102, such as in a backup or “failed” situation, when, for some reason, the power transmission unit 106 is unable to provide fluid to those selected wheel brakes 102. The secondary brake module 132 can be used to selectively provide hydraulic fluid to at least one of the wheel brakes 102 in a backup braking mode, but also in an enhanced braking mode, which can occur on its own and/or concurrently with either the backup braking mode or a non-failure normal braking mode. Examples of suitable enhanced braking mode functions available to the brake system 100 include, but are not limited to, “overboost” (in which higher pressure is provided to a particular brake than would normally be available from the power transmission unit 106 alone) and “volume-add” (in which more fluid is provided to a particular brake than would normally be available from the power transmission unit 106). One of ordinary skill in the art will be readily able to configure a brake system 100 for any particular use application as desired.

In the brake system 100 shown and described herein, the pump pistons 128 are able to pull hydraulic fluid directly from the reservoir 108. During certain phases of operation, the pump pistons 128 may provide pressurized fluid to the power transmission unit 106 via the primary and/or secondary PTU outputs 110, 112, in a manner that tends to “backdrive” the power transmission unit 106. Because there is no brake pedal attached to the power transmission unit 106, this “backdrive” feature is acceptable for operator perception and may be desirable in some circumstances to facilitate brake venting, to avoid working the first and second electric motors 114 and 130 against each other, or for any other desired reason.

Optionally, as indicated by the phantom lines in FIG. 1, an unloading valve 136 and two additional pump pistons 138 may be provided to at least one “side” of the second electric motor 130. In FIG. 1, the at least two pump pistons can be characterized, for the sake of description, as first and second pump pistons 128 and 128′, respectively. Each “side” of the second electric motor—and first and second pump pistons 128 and 128′—accordingly is shown as having two associated additional pump pistons 138 and 138′, respectively

An example of a suitable unloading valve 136 is disclosed in the '048 application. The unloading valve 136 is interposed hydraulically between the at least two additional pump pistons 138 and at least one associated wheel brake 102. Each unloading valve (in some use environments, first and second unloading valves 138 and 138′) is operatively hydraulically connected to a respective set of additional pump pistons 138, 138′ for selectively operating at least one of the first and second pump pistons 128, 128′ in a bypass mode, as described in the '048 application and incorporated herein by reference. Although each “side” of the second electric motor 130 is shown in FIG. 1 as having the optional (phantom line) unloading valve 136, 136′ and additional pump pistons 138, 138′ associated therewith, it is contemplated that only one “side” of the second electric motor 130 could be thus equipped, in some use environments.

It is also contemplated that the secondary brake module 132 could provide pressurized hydraulic fluid during some or all of the normal non-failure “boosted” brake applications in particular use environments, and then the power transmission unit 106 could be used during some or all of the slip control events for those use environments. One of ordinary skill in the art can readily configure a brake system 100 using the present teachings, for a desired use environment.

The brake system 100 also includes at least one electronic control unit or ECU 140. The ECU 140 may include microprocessors and other electrical circuitry. The ECU 140 receives various signals, processes signals, and controls the operation of various electrical components of the brake system 100 in response to the received signals. The ECU 140 can be connected to various sensors such as the reservoir fluid level sensor 109, pressure sensors, travel sensors, switches, wheel speed sensors, and steering angle sensors. The ECU 140 may also be connected to an external module (not shown) for receiving information related to yaw rate, lateral acceleration, longitudinal acceleration of the vehicle, or other characteristics of vehicle operation for any reason, such as, but not limited to, controlling the brake system 100 during vehicle braking, stability operation, or other modes of operation. Additionally, the ECU 140 may be connected to the instrument cluster for collecting and supplying information related to warning indicators such as an ABS warning light, a brake fluid level warning light, and a traction control/vehicle stability control indicator light.

In the brake system 100 shown in FIG. 1, the ECU 140 is a dual lane electronic control unit for controlling at least a portion of the first electric motor 114. The dual lane type ECU 140 includes first and second ECU lanes 142 and 142′, respectively. The first ECU lane 142 is operative to control at least at least a portion of the first electric motor 114, for example, in at least one of the normal non-failure braking mode and the backup braking mode. The second ECU lane 142′ is operative to control the at least a portion of the first electric motor 114, for example, in at least one of the normal non-failure mode and the backup braking mode. For example, if the first electric motor 114 is of a dual wound type, the first ECU lane 142 could control “at least a portion” of the first electric motor 114 by controlling one of the windings, and the second ECU lane 142′ could control “at least a portion” of the first electric motor 114 by controlling the other winding, for redundancy. It is contemplated, though, that both of the first and second ECU lanes 142, 142′ could be controlling respective windings of a dual-wound first electric motor 114 (when configured as such), to provide concurrent driving power to the power transmission unit 106 during normal non-failure braking mode.

The first and second ECU lanes 142, 142′ may be co-located concurrently in a single fluidtight ECU enclosure 144, which is configured to prevent seepage or other entry of fluids (e.g., brake fluid, environmental fluid) which may short out or otherwise harm one or both of the ECU lanes 142, 142′. It is contemplated that the first and second ECU lanes 142, 142′ could be fluidly isolated from each other in separate compartments within the single ECU enclosure 144, as desired, for further avoidance of damage/failure of the brake system 100 due to fluid ingress to the ECU 140.

It is also contemplated that the power transmission unit 106 could be integrated into a common housing with the dual-lane ECU 140. Indeed, for some use environments, the majority, or even all of the components of the brake system 100 may be integrally packaged together in a single unitary housing (as indicated by the dashed line “A” in FIG. 1), as a “one box solution” package which can be provided by one of ordinary skill in the art as desired.

The brake system 100 could also include a second ECU 140′. The second ECU 140′ may of a dual lane or single lane type, but will be shown and described herein as being single lane. Description of common elements and operation of the second ECU 140′ which are similar to those of the first ECU will not be repeated with respect to the second ECU 140′, but should instead be considered to be incorporated below by reference as appropriate. The second ECU 140′, when present, may control the second electric motor 130 in at least one of the normal non-failure braking mode and the backup braking mode. The second ECU 140′ may control at least one of the first and second traction control iso valves 124, 126, and/or at least one of the iso/dump control valve arrangements 118, for example, in the normal non-failure braking mode. The second ECU 140′ may also be operative to control at least a portion of the electric motor 114, for example, in a backup braking mode. Likewise, the first ECU 140 may be operative to control at least one of the second electric motor 130, at least one of the first and second traction control iso valves 124, 126, and/or at least one of the iso/dump control valve arrangements 118 in the backup braking mode. One of ordinary skill in the art will be able to configure first and/or second ECUs 140, 140′ of any desired configuration(s) to control the various other components of the brake system 100 in both the normal non-failure and the backup braking modes, as desired for a particular use application.

In the brake system 100 shown in FIG. 1, each pump piston 128, 128′ is able to route fluid directly to and from the reservoir 108 via the pair of return lines 134, as desired. The reservoir 108 includes first and second reservoir fluid sensors 109, 109′, with each of the first and second reservoir fluid sensors 109, 109′ being in electronic communication with respective first and second ECUs 140, 140′. E.g., each reservoir fluid level sensor 109, 109′ can provide a reservoir fluid level signal to a respective first or second ECU 140, 140′ responsive to a sensed reservoir fluid level. As a result, even if one of the ECUs 140, 140′ is not available to the brake system 100 for some reason, fluid levels in the reservoir 108 can be monitored and adjusted via control of either the first or second electric motor 114 or 130, depending upon which of the first and second ECUs 140, 140′ is still available within the brake system 100 at that time.

It is also contemplated that a selected one of the first and second ECUs 140, 140′ could be a “working” ECU and the other one could be a “backup” ECU, stepping in upon failure of the “working” ECU (either after shadowing the “working” ECU or immediately when pressed into action as a substitute). The same one of the first and second ECUs 140, 140′ could be the “working” version during normal operation of the vehicle, or this role could switch between ECUs during normal operation upon a predetermined schedule, as desired.

In the arrangement of the brake system 100 shown in FIG. 1, a brake pedal unit 104 is remotely located from other structures of the brake system 100, to provide a “brake by wire” configuration. Here, the brake pedal unit 104 is of a deceleration signal transmitter type, which provides the braking signal to at least one ECUs 140, 140′ in a wired or wireless manner exclusively. No manual push-through function is contemplated by the brake system 100 shown in FIG. 1 and described herein. It is also contemplated that the brake pedal unit 104 and related structures may simply be a manually controlled brake arrangement using hand controls or another non-pedal input or may be entirely omitted from the brake system 100, as desired, for a truly autonomous brake arrangement.

The brake pedal unit 104 may include a brake pedal 146 connected thereto, which is selectively actuated by a driver of the vehicle to indicate a desired braking command. The brake pedal unit 104 has at least one brake sensor 148 (four shown, for redundancy) for determining a position of the brake pedal 146 and responsively producing a braking signal corresponding to the desired braking command. The braking signal is transmitted, wired or wirelessly to at least one ECU 140, 140′. The ECUs 140, 140′ control at least one of the power transmission unit 106 and the secondary brake module 132 responsive to the braking signal, to provide pressurized hydraulic fluid to the wheel brakes 102 in either a normal non-failure or backup braking mode. More specifically, the ECUs 140, 140′ control at least one of the first and second electric motors 114, 130 as previously discussed responsive to the braking signal, to selectively provide pressurized hydraulic fluid to the wheel brakes 102 in either a normal non-failure or backup braking mode.

The brake system 100 may include at least one output pressure sensor, with first and second output pressure sensors 150, 150′ shown in FIG. 1 by way of example. Each output pressure sensor 150, 150′ is associated with a selected one of the first and second PTU outputs 110, 112 and is configured to provide a PTU output pressure value to at least one of the first and second ECUs 140, 140′ responsive to sensed pressure at the respective PTU output 110, 112. When the first and second output pressure sensors 150, 150′ are provided, the PTU output pressure values thereby produced can be used, as available, to assist with slip control and/or over-boost control of the wheel brakes 102. As the first and second output pressure sensors 150, 150′ are shown as being optional via phantom line in FIG. 1, one of ordinary skill in the art can readily provide none, one, or both of the depicted output pressure sensors 150, 150′ to the brake system as desired and for any purpose.

The first electric motor 114 is shown in FIG. 1 as being of the dual-wound type, as previously mentioned, having a first winding 152 for operation of the power transmission unit 106 in a first braking mode. The power transmission unit 106 may also include at least one of a third electric motor (not shown) and a second winding on the first electric motor 114, for operation of the power transmission unit 106 in a second braking mode. (This redundancy feature is numbered schematically in FIG. 1 as 154, without distinction as to whether it is merely an additional winding or is an entire additional motor). In many use environments of the brake system 100, the first winding 152 will be controlled by one of the first and second ECU lanes 142, 142′, and the second winding (or third motor) 154 will be controlled by the other of the first and second ECU lanes 142, 142′, again for redundancy in the brake system 100. At least one of the first and second braking modes is a normal non-failure braking mode, though the power transmission unit 106 could be operated as desired in a backup braking mode, additionally or alternatively as previously mentioned. It is contemplated that one of ordinary skill in the art can provide a suitably configured power transmission unit 106 for redundant operation using any desired electrical motor options for a particular use environment of the brake system. Regardless of the nature of the second winding (or third motor) 154, it is contemplated that it could be powered and controlled by a different ECU (e.g., second ECU 140′) than either of the first and second ECU lanes 142, 142′, in some use environments.

Similarly, any of the various first and second electric motors 114, 130; the iso valves 120, the dump valves 122, the first and second traction control iso valves 122, 124, and/or any of the solenoid-controlled components of the brake system 100 may be of a “dual wound” type and/or may have a single wound coil with two separated drive circuits in the brake system 100. As a result, both of the first and second ECUs 140, 140′ would be capable of operating such “redundantly configured” valves and/or motors as desired. Through the redundancy of the first and second electric motors 114, 130, and of the dual windings of the valves of the brake system 100, either of the first and second ECUs 140, 140′ would thus be capable of controlling the entire brake system 100, should the other ECU be unavailable.

Brake motors (not shown) may be provided for selectively electrically actuating any of the corresponding wheel brakes 102, as desired, in parking and/or service modes. It is contemplated that the wheel brakes 102 could each be powered electrically and/or hydraulically—for example, a selected two of the wheel brakes 102 could be electrically powered and an other two of the wheel brakes 102 could be hydraulically powered, and/or at least one of the wheel brakes 102 could be powered electrically during certain phases of operation and hydraulically during other phases of operation, of the same brake system 100. It is also contemplated that one or more hydraulically and/or electrically powered parking brakes (not shown) could be provided to any of the wheels of the vehicle, as desired.

As used herein, the singular forms “a”, “an”, and “the” can include the plural forms as well, unless the context clearly indicates otherwise. It will be further understood that the terms “comprises” and/or “comprising”, as used herein, can specify the presence of stated features, steps, operations, elements, and/or components, but do not preclude the presence or addition of one or more other features, steps, operations, elements, components, and/or groups thereof.

As used herein, the term “and/or” can include any and all combinations of one or more of the associated listed items.

The depiction of certain components in FIG. 1 as being “optional” via phantom lines is not intended or operative to imply that other components are required. The phantom-line components are depicted as such merely to efficiently depict additional configuration embodiments in the same drawing.

It will be understood that when an element is referred to as being “on”, “attached” to, “connected” to, “coupled” with, “contacting”, “adjacent”, etc., another element, it can be directly on, attached to, connected to, coupled with, contacting, or adjacent the other element, or intervening elements may also be present. In contrast, when an element is referred to as being, for example, “directly on”, “directly attached” to, “directly connected” to, “directly coupled” with, “directly contacting”, or “directly adjacent” another element, there are no intervening elements present. It will also be appreciated by those of ordinary skill in the art that references to a structure or feature that is disposed “directly adjacent” another feature may have portions that overlap or underlie the adjacent feature, whereas a structure or feature that is disposed “adjacent” another feature might not have portions that overlap or underlie the adjacent feature.

Spatially relative terms, such as “under”, “below”, “lower”, “over”, “upper”, “proximal”, “distal”, and the like, may be used herein for ease of description to describe one element or feature's relationship to another element(s) or feature(s) as illustrated in the FIGURES. It will be understood that the spatially relative terms can encompass different orientations of a device in use or operation, in addition to the orientation depicted in the FIGURES. For example, if a device in the FIGURES is inverted, elements described as “under” or “beneath” other elements or features would then be oriented “over” the other elements or features.

As used herein, the phrase “at least one of X and Y” can be interpreted to include X, Y, or a combination of X and Y. For example, if an element is described as having at least one of X and Y, the element may, at a particular time, include X, Y, or a combination of X and Y, the selection of which could vary from time to time. In contrast, the phrase “at least one of X” can be interpreted to include one or more Xs.

It will be understood that, although the terms “first”, “second”, etc. may be used herein to describe various elements, these elements should not be limited by these terms. These terms are only used to distinguish one element from another. Thus, a “first” element discussed below could also be termed a “second” element without departing from the teachings of the present disclosure. The sequence of operations (or steps) is not limited to the order presented in the claims or FIGURES unless specifically indicated otherwise.

While aspects of this disclosure have been particularly shown and described with reference to the example aspects above, it will be understood by those of ordinary skill in the art that various additional aspects may be contemplated. For example, the specific methods described above for using the apparatus are merely illustrative; one of ordinary skill in the art could readily determine any number of tools, sequences of steps, or other means/options for placing the above-described apparatus, or components thereof, into positions substantively similar to those shown and described herein. In an effort to maintain clarity in the FIGURES, certain ones of duplicative components shown have not been specifically numbered, but one of ordinary skill in the art will realize, based upon the components that were numbered, the element numbers which should be associated with the unnumbered components; no differentiation between similar components is intended or implied solely by the presence or absence of an element number in the FIGURES. Any of the described structures and components could be integrally formed as a single unitary or monolithic piece or made up of separate sub-components, with either of these formations involving any suitable stock or bespoke components and/or any suitable material or combinations of materials. Any of the described structures and components could be disposable or reusable as desired for a particular use environment. Any component could be provided with a user-perceptible marking to indicate a material, configuration, at least one dimension, or the like pertaining to that component, the user-perceptible marking potentially aiding a user in selecting one component from an array of similar components for a particular use environment. A “predetermined” status may be determined at any time before the structures being manipulated actually reach that status, the “predetermination” being made as late as immediately before the structure achieves the predetermined status. The term “substantially” is used herein to indicate a quality that is largely, but not necessarily wholly, that which is specified—a “substantial” quality admits of the potential for some relatively minor inclusion of a non-quality item. Though certain components described herein are shown as having specific geometric shapes, all structures of this disclosure may have any suitable shapes, sizes, configurations, relative relationships, cross-sectional areas, or any other physical characteristics as desirable for a particular application. Any structures or features described with reference to one aspect or configuration could be provided, singly or in combination with other structures or features, to any other aspect or configuration, as it would be impractical to describe each of the aspects and configurations discussed herein as having all of the options discussed with respect to all of the other aspects and configurations. A device or method incorporating any of these features should be understood to fall under the scope of this disclosure as determined based upon the claims below and any equivalents thereof.

Other aspects, objects, and advantages can be obtained from a study of the drawings, the disclosure, and the appended claims.

I claim:

1. A brake system for actuating a plurality of wheel brakes comprising first and second pairs of wheel brakes, the system comprising:
a power transmission unit configured for selectively providing pressurized hydraulic fluid to first and second PTU outputs for actuating respective first and second pairs of wheel brakes in a normal non-failure braking mode, the power transmission unit including a first electric motor;
an iso/dump control valve arrangement associated with each wheel brake of the first and second pairs of wheel brakes;
a first traction control iso valve hydraulically interposed between the first PTU output and at least one iso/dump control valve arrangement a second traction control iso valve hydraulically interposed between the second PTU output and at least one iso/dump control valve arrangement;
at least two pump pistons, each pump piston being associated with at least one wheel brake, the at least two pump pistons being driven by a second electric motor for selectively providing pressurized hydraulic fluid to the iso/dump control valve arrangement of the at least one associated wheel brake in at least one of a backup braking mode and normal slip control operation;
a reservoir hydraulically connected to the power transmission unit and each of the at least two pump pistons;
a dual lane electronic control unit for at least partially controlling the first electric motor, the dual lane electronic control unit including first and second ECU lanes, wherein the first ECU lane is operative to control at least a portion of the first electric motor in at least one of the normal non-failure braking mode and the backup braking mode, and the second ECU lane is operative to control at least a portion of the first electric motor under at least one of the normal non-failure braking mode and the backup braking mode; and
a single lane electronic control unit for controlling the second electric motor in at least one of the normal non-failure braking mode and the backup braking mode.

2. The brake system of claim 1, wherein at least one of the first and second pump pistons has two additional pump pistons associated therewith, and an unloading valve is interposed hydraulically between the additional pump pistons and at least one associated wheel brake, the unloading valve being operatively hydraulically connected to the additional pump pistons for selectively operating at least one of the first and second pump pistons in a bypass mode.

3. The brake system of claim 2, wherein both of the first and second pump pistons have two additional pump pistons associated therewith for selectively operating the first pump piston in a bypass mode, the unloading valve is a first unloading valve corresponding to the first pump piston, and a second unloading valve is interposed between the additional pump pistons and at least one associated wheel brake, the second unloading valve being operatively hydraulically connected to the additional pump pistons for selectively operating the second pump piston in a bypass mode.

4. The brake system of claim 1, including a reservoir fluid level sensor providing a reservoir fluid level signal to at least one of the first and second ECUs responsive to a sensed reservoir fluid level.

5. The brake system of claim 1, including a first reservoir fluid level sensor providing a first reservoir fluid level signal to a selected one of the first and second ECUs responsive to a sensed reservoir fluid level and a second reservoir fluid level sensor providing a second reservoir fluid level signal to an other one of the first and second ECUs responsive to a sensed reservoir fluid level.

6. The brake system of claim 1, wherein the first and second ECU lanes are co-located concurrently in a single fluidtight ECU enclosure.

7. The brake system of claim 1, wherein all components thereof are integrally packaged in a single unitary housing.

8. The brake system of claim 1, wherein the power transmission unit is a tandem power transmission unit.

9. The brake system of claim 1, wherein the first electric motor has a first winding, for operation of the power transmission unit in a first braking mode, and the power transmission unit includes at least one of a third electric motor and a second winding on the first electric motor for operation of the power transmission unit in a second braking mode; wherein at least one of the first and second braking modes is a normal non-failure braking mode, and wherein the first ECU lane controls the first winding and the second ECU lane controls the at least one of the third electric motor and the second winding.

10. The brake system of claim 1, wherein each of the iso/dump control valve arrangements includes an iso valve and a dump valve providing at least normal non-failure braking control to a corresponding wheel brake.

11. The brake system of claim 1, wherein the power transmission unit is integrated into a common housing with the dual-lane electronic control unit.

12. The brake system of claim 1, including a brake pedal connected to a brake pedal unit and selectively actuated by a driver of the vehicle to indicate a desired braking command, the brake pedal unit having a brake sensor for determining a position of the brake pedal and responsively producing a braking signal corresponding to the desired braking command, the braking signal being transmitted to at least one of the first and second electronic control units, and the at least one of the first and second electronic control units controlling at least one of the first and second electric motors responsive to the braking signal.

13. The brake system of claim 12, wherein the braking signal is wirelessly transmitted to the electronic control unit.

14. The brake system of claim 1, wherein the first and second pairs of wheel brakes are front and rear pairs of wheel brakes.

15. The brake system of claim 1, wherein each of the first and second pairs of wheel brakes includes a front wheel brake from a selected lateral side of the vehicle and a rear wheel brake from an opposite lateral side of the vehicle.

16. The brake system of claim 1, including an output pressure sensor, the at least one output pressure sensor being associated with a selected PTU output and being configured to provide a PTU output pressure value to at least a selected one of the first and second electronic control units responsive to sensed pressure at the selected PTU output.

17. The brake system of claim 16, including a second output pressure sensor, the second output pressure sensor being associated with an other PTU output and being configured to provide a PTU output pressure value to at least an other one of the first and second electronic control units responsive to sensed pressure at the other PTU output.

18. The brake system of claim 1, wherein the second electronic control unit is operative to control at least one of the second electric motor 130, at least one of the first and second traction control iso valves 124, 126, and at least one of the iso/dump control valve arrangements 118 in at least one of the normal non-failure braking mode and the backup braking mode.
